(19) United States
(12) Patent Application Publication
(10) Pub. No.: US 2011/0186357 A1
(43) Pub. Date: Aug. 4, 2011

(54) Handheld Electronic Luggage Scale

(75) Inventor: Haroon Sheikh, Miami, FL (US)

(73) Assignee: Heys (USA), Inc., Miami, FL (US)

(21) Appl. No.: 12/829,136

(22) Filed: Jul. 1, 2010

Related U.S. Application Data
(60) Provisional application No. 61/299,752, filed on Jan. 29, 2010.

(51) Int. Cl. G01G 19/52

(52) U.S. Cl. 177/148

(57) ABSTRACT

A hand-held electronic luggage scale includes a handle designed to be held generally horizontally, and a hook supported by the handle, which extends generally vertically below the handle. The handle houses an electronic scale, the electronic scale connected to the hook for calculating a weight of an object suspended from the hook. An easy-to-read digital display is provided in a top surface of the handle, the display displaying the calculated weight from the electronic scale component. The hook is supported by the handle at a central portion of the handle such that a user's two hands can hold the handle on either side of a hook attachment while leaving the display visible between the user's hands. The handle curves downwardly from the central portion the handle to free ends thereof to provide an ergonomic support for the user to lift the object to be weighed.

### RELATED APPLICATIONS AND PRIORITY

The present application claims priority to U.S. Provisional Application No. 61/299,752, filed Jan. 29, 2010, the entirety of which is hereby incorporated by reference.

### FIELD OF THE INVENTION

The present invention relates to a handheld luggage scale, and in particular to a compact, lightweight luggage scale that is easy for a user to hold.

### BACKGROUND

Airlines have over time become stricter about luggage size and weight limits, and have introduced high fees for conveying luggage that is over their weight limit. Weight and size limits for luggage can vary from airline to airline, and even by type of flight (for example, international flights typically have a higher weight limit than domestic flights), and a consumer can no longer know in advance whether an item of luggage will meet size and weight restrictions. It has thus become more important to travelers to be able to measure the weight of their luggage before they set out to travel to an airport to check in for a flight. Various consumer-oriented luggage scales have been proposed, but most of the known scales suffer from various drawbacks.

In particular, it is often difficult for people to lift luggage items safely, which luggage scales require them to do. Because they do not necessarily know the proper safe lifting techniques, a person can easily injure their back while lifting luggage, especially if they are not in good physical condition. Most of the known portable electronic scales do not help a person to lift their luggage safely. Also the known scales may have handles which are uncomfortable to hold, may require the person to lift the luggage high up in order to view the weight read-out, and may not allow two-handed operation.

It is therefore desirable to provide novel designs of luggage scales for consumer use, particularly those which are easy to use and which provide ergonomic advantages.

### SUMMARY

The invention relates to a handheld electronic luggage scale. The scale includes a handle designed to be held generally horizontally, and a hook supported by the handle, which extends generally vertically below the handle. The handle houses an electronic scale component, the electronic scale component connected to the hook for calculating a weight of an object suspended from the hook. An easy-to-read digital display is provided in a top surface of the handle, the display displaying the calculated weight from the electronic scale component. The hook is supported by the handle at a central portion of the handle such that a user's one or two hands can hold the handle on either side of a hook attachment while leaving the display at the top of the handle visible between the user's hand(s) while the user is holding the handle. The handle is curved downwardly from the central portion of the handle to free ends thereof to provide an ergonomic support for the user to lift the object to be weighed.

In one aspect, a handheld electronic luggage scale may be provided. The handheld electronic luggage scale may include a handle designed to be held generally horizontally, and a curved hook supported by the handle, and extending generally vertically below the handle. The handle may act as a housing for at least one electronic scale component. The electronic scale component may be connected to the curved hook for calculating a weight of an object suspended from the curved hook. The handle may include a display provided in a top surface of the handle that is configured to display the weight calculated by the electronic scale component. The curved hook may be supported by the handle at a central portion of the handle such that a user can hold the handle on either side of a hook attachment with either one or two hands while leaving the display at the top of the handle visible. The bottom surface of the handle may be curved from the central portion the handle to both ends of the handle to provide an ergonomic support for the user to lift the object to be weighed.

In another aspect, a handheld electronic luggage scale may be provided. The handheld electronic luggage scale may include a handle designed to be held generally horizontally and a luggage hook attachment that is centrally located on a bottom surface of the handle. The luggage hook attachment may protrude from the bottom surface of the handle in the downward direction. The handheld electronic luggage scale may include a connector housed within the luggage hook attachment with an opening at one end; a curved hook having a diameter sized to be accepted by the opening of the connector such that the curved hook is supported by the connector and extends generally vertically below the handle; an electronic scale housed within the handle and that is interconnected with the curved hook via the connector for calculating a weight of an object suspended from the curved hook; and a display provided on a top surface of the handle for displaying the calculated weight from the electronic scale component. The bottom surface of the handle is curved from the luggage hook attachment centrally located on the bottom surface of the handle to both longitudinal ends of the bottom surface of the handle to provide an ergonomic support for the user while lifting the object to be weighed. During use, the handheld electronic luggage scale provides for lifting the object to be weighed and then displaying the weight of the object that is calculated by the electronic scale on the display.

In another aspect, a handheld electronic luggage scale may be provided. The handheld electronic luggage scale may include a handle; an electronic scale component configured to weigh an object for which the handle acts as a housing for; a luggage hook attachment that is centrally located on the handle and that protrudes from a bottom surface of the handle in the downward direction; and a connector housed within the luggage hook attachment with an opening at one end. The one end of the connector with the opening may extend below the luggage hook attachment. The handheld electronic luggage scale may include a curved hook having a diameter sized to be accepted by the opening of the connector such that the curved hook is supported by the connector and interconnected with the electronic scale component via the connecter. The curved hook may extend generally vertically below the handle. The handheld electronic luggage scale may further include a display provided in a top surface of the handle that is configured to display the weight of the object being lifted via the curved hook that is calculated by the electronic scale component. During use, when an object hooked by the curved hook is lifted via the handle, the electronic scale component calculates a weight of the object and the weight of the object calculated is displayed on the display.

In another aspect, a handheld electronic luggage scale may be provided. The handheld electronic luggage scale may include a handle and a connector. A top portion of the connector may be housed within the handle. A bottom portion of the connector may extend from a bottom of the handle. The bottom portion of the connector may have an opening or hole. The handheld electronic luggage scale may have a circular hook having a diameter sized to be accepted by the opening of the bottom portion of the connector such that the circular hook is vertically supported by the connector and extends below the bottom of the handle. The circular hook may have a radial curvature of at least approximately 180 degrees. The handheld electronic luggage scale may include an electronic scale component that is housed within the handle. The electronic scale component may be interconnected with the connector and configured to calculate a weight of an object suspended from the circular hook. An electronic display may be provided in a top surface of the handle and be approximately flush with the top surface of the handle. The display may be configured to display the calculated weight from the electronic scale component and configured to change illumination. The electronic scale component may include two control buttons provided in the top surface between a first end of the handle and the display provided in the top surface of the handle; and a battery hatch in the top surface of the handle between the display provided in the top surface of the handle and a second end of the handle, the second end of the handle being opposite the first end of the handle. During use, the handheld electronic luggage scale may calculate the weight of the object suspended from the circular hook and display the weight calculated on the electronic display in the top surface.

### BRIEF DESCRIPTION OF THE DRAWINGS

There are shown in the drawings arrangements which are presently discussed, it being understood, however, that the invention is not limited to the precise arrangements and instrumentalities shown, wherein:

FIG. 1 illustrates an exemplary top perspective view of a handheld electronic luggage scale according to the present embodiments;

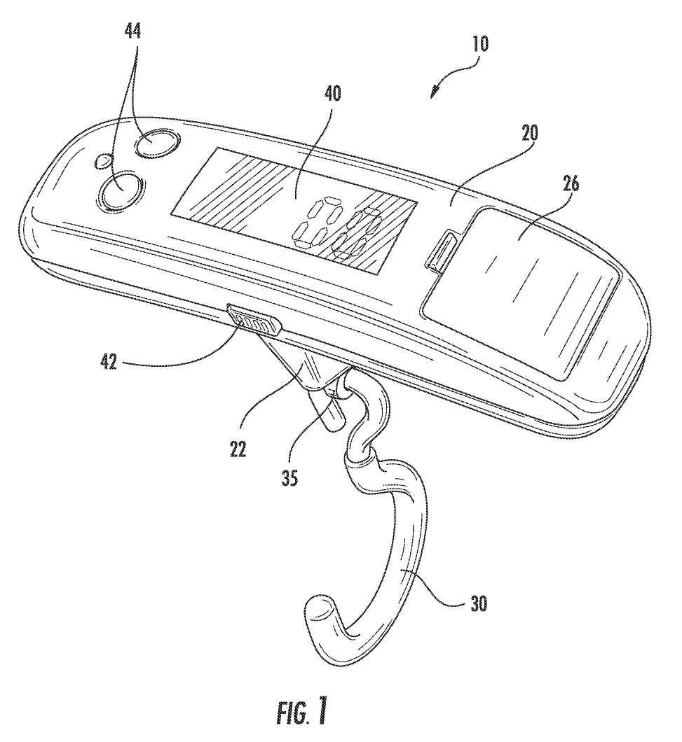

FIG. 2 illustrates an exemplary bottom side perspective view of the handheld electronic luggage scale of FIG. 1;

FIG. 3 illustrates an exemplary view illustrating two-hand operation of the handheld electronic luggage scale; and

FIG. 4 illustrates an exemplary method of use of the handheld electronic luggage scale.

### DETAILED DESCRIPTION OF THE INVENTION

The present invention is directed to a handheld electronic luggage scale, and in particular to a compact, lightweight luggage scale that is easy for a user to hold. The term “luggage” as used herein is not meant to be limiting, as the luggage scale can be used for anything that can be hung from a hook. For example, the term “luggage” may cover a suitcase, a briefcase, a laptop bag/case, a computer bag/case, a business case, a travel bag, a beauty case, or a variety of other types of luggage. The scale can also be used with packages, parcels and other items that a user may wish to weigh prior to shipping or posting.

Referring to the drawings, a handheld electronic luggage scale 10 is shown, comprising a handle 20 having a hook attachment 22, a coated luggage hook 30 and an easy-to-read display 40. The handle 20 is designed to be held generally horizontally, with the hook attachment 22 extending generally vertically from the bottom of the handle 20, at a central portion of the handle.

The handle 20 is designed to be small enough to fit snugly within a user's two hands, or a single hand, as they are held in front of the body. In one arrangement, the handle 20 can be approximately 4-5″ long. The handle can also be picked up with one hand if desired, with the luggage hook attachment 22 passing between the middle fingers. The handle 20 is designed with a slight curve so that ends 24 of the handle 20 either side of the central hook attachment 22 curve slightly downwardly. The ends 24 can have a greater angle of curvature from horizontal than a central portion of the handle 20. The handle 20 has a suitable length and width so that it fits comfortably in a user's hand or hands.

The handle 20 serves as a housing for internal components and can also include a battery hatch 26. Batteries within the hatch 26 provide power to an electronic scale component (not shown) that is stored within the handle 20. The scale component is also connected to the luggage hook 30 by means of a connector 35 that extends within the hook attachment 22. The luggage hook 30 may be simply hooked through an aperture provided in a free end of the connector 35. As the connector 35 is pulled downwardly, the electronic scale component registers the force acting on the connector 35, and thus the weight of an object that is suspended from the hook 30.

An easy-to-read widescreen digital display 40 is provided on top of the handle 20. The display 40 displays the luggage weight in numbers large enough to be easily viewed by a person holding the handle 20 at about waist height. The display 40 can be an LCD display and it can have blue back lighting for ease of viewing. Of course, any suitable display may be used, and the invention is not limited in this regard. An on/off switch 42 may be provided on the side of the handle 20, and one or more control buttons 44 can be provided on the top of the handle 20. After turning the main on/off switch 42 on, one of the control buttons 44 allows the user to activate the scale 10 to provide a readout of the weight once an item of luggage 50 has been picked up. The electronic scale component reads the weight of the luggage 50 instantly, and can beep as it provides the readout. The display 40 can also change color, for example, to red, when the readout is provided. This provides the user quick notification that the weight reading is completed and that they can set the luggage item 50 back down on the ground. A second control button 44 allows the weight display to be toggled between kilograms and pounds.

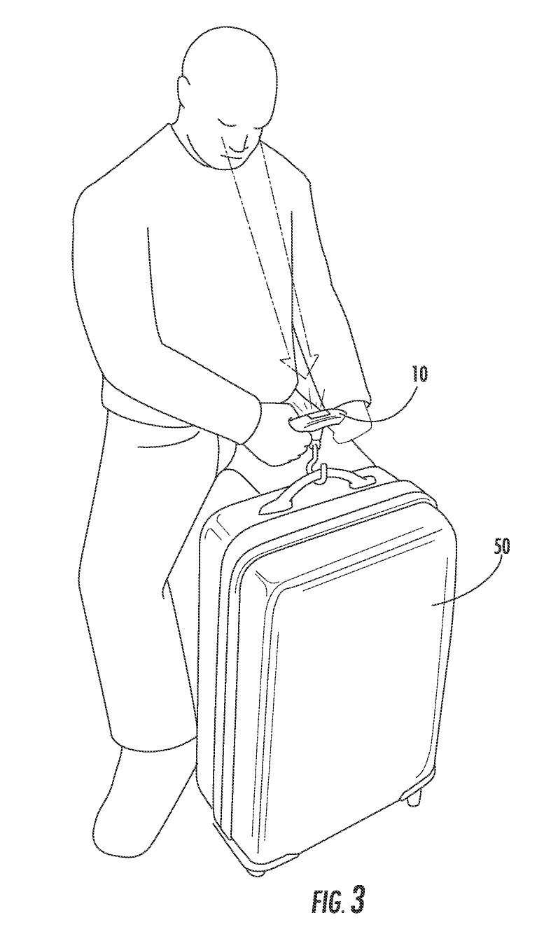

The curvature of the handle 20 is designed to provide both comfort and a secure grip to a user, and to assist with safe lifting techniques which should always be practiced to properly lift objects and reduce back strain. This operation is shown in FIG. 3. The user stands close to an item of luggage 50 to be weighed, with their legs shoulder-width apart. The user centers themselves with the electronic scale 10 comfortably resting in their hands. The user connects the hook 30 to a carry handle of the luggage 50. The luggage 50 is then lifted by the user while closely holding the arms to their body, preferably bending their legs while keeping their back straight. As a person raises their arms along their midline, the hands naturally define a greater and greater angle from the horizontal as their elbows splay, and the curvature of the handle 20 of the scale 10 allow for this operation to be carried out comfortably while the user maintains the weight of the luggage 50 evenly across the width of their hands. It has been found that with a straight handle, as the user raises their hands, the weight of the luggage 50 becomes more focused on the ulnar edges of the hands, which can quickly become painful.

Alternatively or additionally, with respect to FIG. 3, the user may operate the handheld electronic luggage scale 10 with one hand. The user may grip the scale 10 with one hand such that the user may be able to view the weight of an object being calculated by the scale 10 and that is being displayed on the display on the top surface of the scale 10. For instance, the display may be viewable between a user's thumb and index finger when gripping the luggage scale 10 with one hand. The one-hand operation may be useful for smaller and/or lighter items as compared to the two-hand operation. The digital display may be sufficiently large to permit viewing of the calculated weight from a distance, such as when the user is hold the luggage scale 10 at arm's length during use or about waist high.

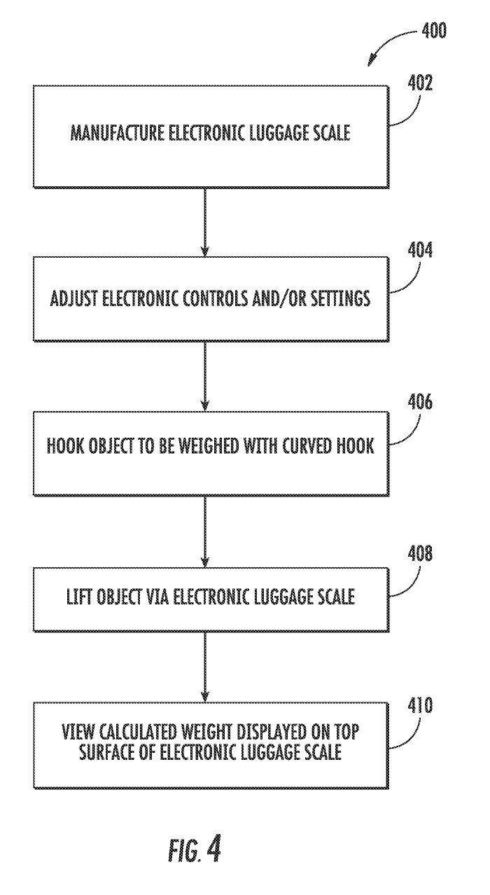

FIG. 4 depicts an exemplary method of using the handheld electronic luggage scale 400. The method 400 may include manufacturing the handheld electronic luggage scale 402, attaching the scale to an object to be weighed 404, adjusting controls and/or settings on the scale 406, lifting the scale and object 408, and viewing the weight of the object being weighed 410. The method may include additional, fewer, or alternate actions.

The method of using the handheld electronic luggage scale 400 may include manufacturing the handheld electronic luggage scale 402. The handheld electronic luggage scale may be manufactured to include a handle or outer casing for casing an electronic scale. The luggage scale may have a digital display on the top surface of the handle to facilitate viewing a weight displayed during use. The luggage scale may include a hook attachment/connector arrangement on the bottom surface of the handle for either direct or indirect attachment to an object to be weighed. The hook attachment may house a connector that may be interconnected with the electronic scale cased within the handle, such that during use, the electronic scale may weigh the object to be weighed. In one embodiment, a bottom end of the connector extends from the hook attachment and is interconnected with a substantially coated luggage hook. The handle may be designed to be held horizontally during use, with the hook attachment and/or luggage hook extending vertically from the bottom of the handle, preferably in the vicinity of a central portion of the handle.

The handle may be designed to be small enough to fit snugly within a user's hand or hands. The handle may be approximately three to several inches in length, preferably between approximately four to approximately five inches. In one aspect, the handle may be picked up with one hand, with the luggage hook attachment passing between two fingers when the user is gripping the handle.

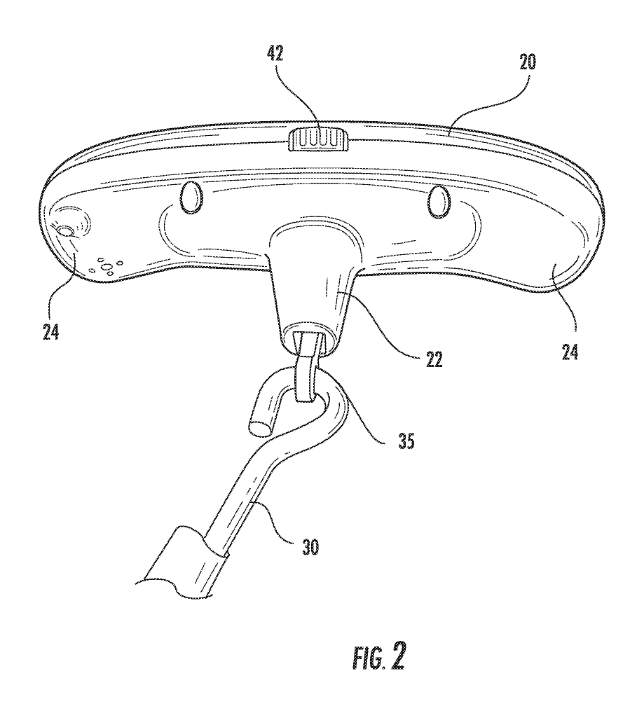

As shown with respect to FIG. 2, in one embodiment, the luggage hook attachment 22 may be centrally located on the handle 20 and protrude from the bottom of the handle 20. The luggage hook attachment 22 may be generally cylindrical, or tapered and/or funnel shaped with a smooth exterior. The luggage hook attachment 22 may extend from a mid-section of the bottom surface of the handle 20 for approximately 0.25 inches to approximately 2.00 inches. Other sizes may be used. The radius of the luggage hook attachment 22 may be greater in the vicinity of the interconnection of the luggage hook attachment with the bottom of the handle, and smaller in the vicinity of the tip of the luggage hook attachment 22. The tip of the luggage hook attachment 22 may have an a square, round, or other opening leading to a hollow cavity interior of the luggage hook attachment 22.

Further with respect to FIG. 2, the handle may be configured to have a connector 35 that protrudes or extends from the tip or bottom of the luggage hook attachment 22. The connector 35 may be substantially housed within the interior of the luggage hook attachment 22. The connector 35 may have a circular opening at the bottom end configured to accept a luggage hook 30. The opening of the connector 35 may be approximately perpendicular or parallel to the longitudinal length of the handle 20.

As shown in FIG. 2, the luggage hook 30 may have a large, circular hook for hooking luggage and other items, such as by handles on the items to be lifted. The large, circular hook may be coated with a rubber or plastic material. The large, circular hook of the luggage hook 30 may transition to a smaller connector hook. The smaller connector hook may sized to be accepted by the opening of the connector 35 that extends from the luggage hook attachment 22. The transition portion of the luggage hook 30 may having a twisting effect and transition or re-orientate the alignment of the smaller connector hook, which may run approximately parallel to the longitudinal length of the handle 20, by approximately 90 degrees, such that the alignment of the larger, circular hook is approximately perpendicular to the longitudinal length of the handle 20. Other configurations and orientations may be used.

The handle may have a slight curve such that the two longitudinal ends of the handle on either side of the central hook attachment curve slightly downward. The top surface of the handle may curve slightly downward from a central or mid-section to both longitudinal ends of the top surface. The bottom surface of the handle may curve slightly upward and then curve slightly downward from a central or mid-section to both longitudinal ends of the bottom surface, as shown in FIG. 2.

The handheld electronic luggage scale may be manufactured to have a battery hatch located in a top or other surface of the handle. The battery hatch may be located between an electronic display, such as a centrally located or other electronic display on the top surface of the handle, and one longitudinal end of the handle of the scale. The batteries within the hatch may power the electronic scale housed within the handle.

The method of using the handheld electronic luggage scale 400 may include adjusting controls and/or settings on the scale 404. The handle may include an on/off switch for turning the electronic luggage scale on and off. The handle also may include one or more control buttons on the top or other surface of the handle. Two control buttons may be located between the electronic display, such as a centrally located or other electronic display on the top surface of the handle, and the other longitudinal end of the top surface of the handle—the other longitudinal end of the top surface of the handle being opposite the longitudinal end of the top surface of the handle that is closest to the battery hatch.

The user may be able to grab the electronic luggage scale with one hand and operate either of the two control buttons with his or her thumb, similar to remote control operation of a television set. One control button may allow the user to activate the scale and provide a readout of the weight once an item of luggage has been lifted and weighed. The electronic scale component reads the weight of the luggage instantly, and may beep as it provides the readout. The display may be configured to change color or give another indication that a readout is ready for viewing. Another control button may allow the weight display to be toggled between kilograms and pounds, or other units of measurement.

The method of using the handheld electronic luggage scale 400 may include attaching the scale to an object to be weighed 406. The electronic scale component may be interconnected to a luggage hook either directly or indirectly. For example, the luggage hook may be interconnected with a connector or other means that connects the luggage hook to the handheld electronic luggage scale. In one embodiment, the hook supported by the handle may interconnected with the handle via a connector having a vertical alignment that is offset from a vertical alignment of the hook by approximately 90 degrees. The luggage hook may be slid through an aperture on the connector and then hook a handle on a piece of luggage or suitcase, such that the piece of luggage or suitcase is sufficiently attached to the handheld electronic luggage scale.

The hook may be a curved or circular hook. The curved or circular hook may be manufactured of metal, plastic, or other material. The curved hook may include a bottom or large hook portion, and a top or small hook portion. Both the large hook portion and the small hook portion may be configured as curved or circular hooks.

The large hook portion may have a bottom curved hook extending at least approximately 180 degrees radially. In one embodiment, the bottom curved hook may extend approximately 270 degrees radially or have 270 degrees of curvature for hooking or grabbing an object. The bottom curved hook may be configured to be sufficiently strong such that the bottom curved hook may hook a handle or strap on an object, and then be used in conjunction with the handle to lift the object.

The curved hook may include a top or small hook portion having a top curved hook extending from the large hook portion. The vertical alignment of the small hook portion and the vertical alignment of the large hook portion may be approximately 90 degrees offset with respect to each other. The top or small hook portion may have a vertical alignment that is approximately parallel to the longitudinal length of the handle. The bottom or large hook portion may have a vertical alignment that is approximately perpendicular to the longitudinal length of the handle. Other vertical alignments of the top and bottom hook portions may be used.

The method of using the handheld electronic luggage scale 400 may include lifting the scale and object 408. During use, as the user lifts the object using the handle of the luggage scale, the connector may be pulled downward. As a result, the electronic scale component may register the force acting on the connector, and thus the weight of an object that is suspended from the hook may be calculated. The electronic scale may provide an audible and/or visual indication that the weight of the object has been calculated and is being displayed. For instance, the display may change background color or an indicator light may light up to provide a user notification that the weight reading is complete. The indicator light may be located on the surface of the handle between two control buttons and one longitudinal end of the top surface of the handle.

The method of using the handheld electronic luggage scale 400 may include viewing the weight of the object being weighed 410. The top surface of the handle, or another surface of the handle, may include a digital display. The digital display may have a square or other shaped display screen. The display may display luggage weight in numbers large enough to be easily viewed by a person holding the handle at about waist height. The display may be a LCD display and may have colored lighting for ease of viewing. The digitally displayed numbers may be displayed vertically or horizontally with respect to the length of the handle. In one embodiment, the user may lift the object to be weighed via the handle using one hand while simultaneously being able to view the digital display that is displaying the weight of the object calculated by the electronic scale. In another embodiment, the user may lift the object to be weighed via the handle using two hands while simultaneously being able to view the digital display that is displaying the weight of the object calculated by the electronic scale.

In one exemplary embodiment, the handheld electronic luggage scale may include a handle; an electronic scale component configured to weigh an object for which the handle acts as a housing for; a luggage hook attachment that is centrally located on the handle and that protrudes from a bottom surface of the handle in the downward direction; and a connector housed within the luggage hook attachment with an opening at one end. The one end of the connector with the opening may extend below the luggage hook attachment. The handheld electronic luggage scale may include a curved hook having a diameter sized to be accepted by the opening of the connector such that the curved hook is supported by the connector and interconnected with the electronic scale component via the connecter. The curved hook may extend generally vertically below the handle. The handheld electronic luggage scale may further include a display provided in a top surface of the handle that is configured to display the weight of the object being lifted via the curved hook that is calculated by the electronic scale component. During use, when an object hooked by the curved hook is lifted via the handle, the electronic scale component calculates a weight of the object and the weight of the object calculated is displayed on the display.

In another exemplary embodiment, the handheld electronic luggage scale may include a handle and a connector. A top portion of the connector may be housed within the handle. A bottom portion of the connector may extend from a bottom of the handle. The bottom portion of the connector may have an opening or hole. The handheld electronic luggage scale may have a circular hook having a diameter sized to be accepted by the opening of the bottom portion of the connector such that the circular hook is vertically supported by the connector and extends below the bottom of the handle. The circular hook having a radial curvature of at least approximately 180 degrees. The handheld electronic luggage scale may include an electronic scale component that is housed within the handle. The electronic scale component may be interconnected with the connector and configured to calculate a weight of an object suspended from the circular hook. An electronic display may be provided in a top surface of the handle and be approximately flush with the top surface of the handle. The display may be configured to display the calculated weight from the electronic scale component and configured to change illumination. The electronic scale component may include two control buttons provided in the top surface between a first end of the handle and the display provided in the top surface of the handle; and a battery hatch in the top surface of the handle between the display provided in the top surface of the handle and a second end of the handle, the second end of the handle being opposite the first end of the handle. During use, the handheld electronic luggage scale may calculate the weight of the object suspended from the circular hook and display the weight calculated on the electronic display in the top surface. The weight calculated may be displayed and viewable by the user while the user is still lifting the object. The weight calculated may also be displayed and viewable by the user after the user puts the object down. Embodiments having additional, fewer, or alternate features may be used.

The arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

1. A handheld electronic luggage scale comprising:
a handle;
a curved hook supported by the handle, and extending generally vertically below the handle;
the handle acting as a housing for at least one electronic scale component, the electronic scale component connected to the curved hook for calculating a weight of an object suspended from the curved hook; and
a display provided in a surface of the handle, the display displaying the calculated weight from the electronic scale component,
wherein the curved hook is supported by the handle at a central portion of the handle such that a user can hold the handle on either side of a hook attachment with either one or two hands while leaving the display at the top of the handle visible, and a bottom surface of the handle is curved from the central portion the handle to both ends of the handle to provide an ergonomic support for the user to lift the object to be weighed.

2. The handheld electronic luggage scale of claim 1, wherein the display is provided in a top surface of the handle, and the top surface of the handle further includes two round control buttons between a first end of the handle and the display, the display comprising a square display screen.

3. The handheld electronic luggage scale of claim 2, wherein the curved hook supported by the handle is interconnected with the handle via a connector, the curved hook having a small hook portion sized to be accepted by an opening on the connector and a large hook portion configured to hook luggage handles, the small hook portion having a vertical alignment that is approximately parallel to a longitudinal length of the handle and the large hook portion having a vertical alignment that is approximately perpendicular to the longitudinal length of the handle.

4. The handheld electronic luggage scale of claim 3, wherein the handheld electronic luggage scale further comprises a battery hatch in the top surface of the handle between the display provided in the top surface of the handle and a second end of the handle, the second end of the handle being opposite the first end of the handle.

5. The handheld electronic luggage scale of claim 3, wherein the handle further includes a luggage hook attachment that is centrally located on the bottom surface of the handle and protrudes from the bottom surface of the handle.

6. The handheld electronic luggage scale of claim 5, the luggage hook attachment being generally funnel shaped and having an exterior with a tapered radius, the luggage hook attachment configured to house the connector and facilitate maintaining a firm grip on the handheld electronic luggage scale while lifting the object.

7. A handheld electronic luggage scale comprising:
a handle;
a luggage hook attachment that is centrally located on a bottom surface of the handle, the luggage hook protruding from the bottom surface of the handle in the downward direction:
a connector housed within the luggage hook attachment with an opening at one end;
a curved hook having a diameter sized to be accepted by the opening of the connector such that the curved hook is supported by the connector and extends generally vertically below the handle;
an electronic scale housed within the handle, the electronic scale interconnected with the hook via the connector for calculating a weight of an object suspended from the curved hook; and
a display provided on a surface of the handle, the display displaying the calculated weight from the electronic scale component,
wherein the bottom surface of the handle is curved from the luggage hook attachment centrally located on the bottom surface of the handle to both longitudinal ends of the bottom surface to provide an ergonomic support for the user to lift the object to be weighed, and the handheld electronic luggage scale provides for lifting the object to be weighed and then displaying the weight of the object that is calculated by the electronic scale on the display.

8. The handheld electronic luggage scale of claim 7, wherein the display is provided on a top surface of the handle, and the top surface of the handle includes two round control buttons between a first end of the handle and the display.

9. The handheld electronic luggage scale of claim 8, wherein the curved hook supported by the connector is configured to have a small hook portion sized to he accepted by an opening on the connector and a large hook portion configured to hook luggage, the small hook portion having a vertical alignment that is approximately parallel to a longitudinal length of the handle and the large hook portion having a vertical alignment that is approximately perpendicular to the longitudinal length of the handle.

10. The handheld electronic luggage scale of claim 8, wherein the handheld electronic luggage scale further comprises a battery hatch in the top surface of the handle between the display provided in the top surface of the handle and a second end of the handle, the other end of the handle being opposite the one end of the handle.

11. The handheld electronic luggage scale of claim 8, wherein the display is configured to change colors after the weight of the object to be weighed has been calculated by the electronic scale to provide a visual indication that the object can be set back down on the ground.

12. The handheld electronic luggage scale of claim 8, wherein the handheld electronic luggage scale is configured to provides an audible or visual indication that the weight of the object has been calculated by the electronic scale.

13. A handheld electronic luggage scale comprising:
a handle;
an electronic scale component configured to weigh an object, the handle acting as a housing for the electronic scale component;
a luggage hook attachment that is centrally located on the handle, the luggage hook attachment protruding from a bottom surface of the handle in the downward direction;
a connector housed within the luggage hook attachment with an opening at one end, the one end of the connector with the opening extending below the luggage hook attachment;
a curved hook having a diameter sized to be accepted by the opening of the connector such that the curved hook is supported by the connector and interconnected with the electronic scale component via the connecter, the curved hook extending generally vertically below the handle;
a display provided in a top surface of the handle, the display displaying the calculated weight of the object being lifted via the curved hook from the electronic scale component,
wherein when an object hooked by the curved hook is lifted via the handle, the electronic scale component calculates a weight of the object and the weight of the object calculated is displayed on the display.

14. The handheld electronic luggage scale of claim 13, wherein the bottom surface of the handle is curved from the luggage hook attachment that is centrally located to a first and a second longitudinal end of the handle to provide an ergonomic support for the user to lift the object to be weighed.

15. The handheld electronic luggage scale of claim 13, wherein the curved hook comprises a large hook portion having a bottom curved hook extending at least approximately 180 degrees radially, the bottom curved hook configured to hook a handle or strap on the object.

16. The handheld electronic luggage scale of claim 15, wherein the curved hook comprises a small hook portion having a top curved hook extending from the large hook portion, the vertical alignment of the small hook portion and the vertical alignment of the large hook portion being approximately 90 degrees offset with respect to each other.

17. The handheld electronic luggage scale of claim 13, wherein the top surface of the handle includes two round control buttons and an indicator light between a first end of the handle and the display provided in the top surface of the handle.

18. The handheld electronic luggage scale of claim 17, wherein the handheld electronic luggage scale further comprises a battery hatch in the top surface of the handle between the display provided in the top surface of the handle and a second end of the handle, the second end of the handle being opposite the first end of the handle.

19. A handheld electronic luggage scale comprising:
a handle;
a connector, a top portion of the connector housed within the handle and a bottom portion of the connector extending from a bottom of the handle, the bottom portion of the connector having an opening;
a circular hook having a diameter sized to be accepted by the opening of the bottom portion of the connector such that the circular hook is supported by the connector and extends below the bottom of the handle, the circular hook having a radial curvature of at least approximately 180 degrees;
an electronic scale component housed within the handle, the electronic scale component is interconnected with the connector and configured to calculate a weight of an object suspended from the circular hook;
an electronic display provided in a top surface of the handle and being approximately flush with the top surface of the handle, the display displaying the calculated weight from the electronic scale component and configured to change illumination;
two control buttons provided in the top surface between a first end of the handle and the display provided in the top surface of the handle; and
a battery hatch in the top surface of the handle between the display provided in the top surface of the handle and a second end of the handle, the second end of the handle being opposite the first end of the handle,
wherein the handheld electronic luggage scale calculates the weight of the object suspended from the circular hook and displays the weight calculated on the electronic display in the top surface.

20. The handheld electronic luggage scale of claim 19, wherein the display is configured to change colors after the weight of the object suspended from the circular hook has been calculated by the handheld electronic luggage scale to provide a visual indication that the object can be set down.

21. The handheld electronic luggage scale of claim 1, wherein the display is configured to change colors after the weight of the object to be weighed has been calculated by the electronic scale component to provide a visual indication that the object can be set back down on the ground.

22. The handheld electronic luggage scale of claim 13, wherein the handheld electronic luggage scale is configured to provide an audible or visual indication that the weight of the object has been calculated by the electronic scale component.
